(19) United States
(12) Patent Application Publication
(10) Pub. No.: US 2026/0361965 A1
(43) Pub. Date: Nov. 12, 2026

(54) VIDEO PLAYBACK METHOD, APPARATUS AND DEVICE, AND STORAGE MEDIUM AND PROGRAM PRODUCT

(71) Applicant: Beijing Youzhuju Network Technology Co., Ltd., Beijing (CN)

(72) Inventors: Haoran LI, Beijing (CN); Jin BAI, Beijing (CN)

(21) Appl. No.: 19/670,378

(22) Filed: May 7, 2026

(30) Foreign Application Priority Data
May 12, 2025 (CN) 202510607496.7

(51) Int. Cl. H04N 21/472; H04N 21/431

(52) U.S. Cl. CPC H04N 21/47217; H04N 21/4316

(57) ABSTRACT

Embodiments of the present disclosure relate to a video playback method, an apparatus, a device, a storage medium and a program product. The method includes: playing a target video in a video playback interface in a first mode in response to a triggering operation on the target video including a target object, where in the first mode interface elements irrelevant to video content of the target video are displayed in the video playback interface; switching from the first mode to a second mode and continuing playback of the target video in response to detecting a preset condition, where in the second mode the interface elements are hidden; and displaying a mode exit control and at least one custom component corresponding to the target object in an edge region of the video playback interface to display extended information at least one of the target object or an attribution party of the target object, where the extended information is information other than the video content.

### CROSS-REFERENCE TO RELATED APPLICATIONS

The present application is based on and claims priority of CN Application No. 202510607496.7, filed on May 12, 2025, the disclosure of which is incorporated by reference herein in its entirety.

### TECHNICAL FIELD

The present disclosure relates to the technical field of video processing and, in particular, to a video playback method, an apparatus, a device, a storage medium and a program product.

### BACKGROUND

With various types of videos becoming more and more popular, there are cases where a certain object (such as a physical product, a virtual service, a supplier that provides products/services, etc.) is promoted or recommended through a video. This type of video has a high requirement for the visibility of video content/video material.

### SUMMARY

Embodiments of the present disclosure provide a video playback method, an apparatus, a device, a storage medium and a program product.

In a first aspect, an embodiment of the present disclosure provides a video playback method, and the method includes:
playing a target video in a video playback interface in a first mode in response to a triggering operation on the target video; where the target video includes at least a target object; and in the first mode, interface elements irrelevant to video content of the target video are displayed in the video playback interface;
switching from the first mode to a second mode and continuing the playback of the target video in the second mode in response to detecting a preset condition; where in the second mode the interface elements are not displayed in the video playback interface; and
displaying a mode exit control and at least one custom component corresponding to the target object in an edge region of the video playback interface; where the custom component is used for displaying extended information of the target object and/or an attribution party of the target object, and the extended information is information other than the video content.

In a second aspect, an embodiment of the present disclosure further provides a video playback apparatus, and the apparatus includes:
a target video playback module, configured to play a target video in a video playback interface in a first mode in response to a triggering operation on the target video; where the target video includes at least a target object; and in the first mode interface elements irrelevant to video content of the target video are displayed in the video playback interface;
a second mode switching module, configured to switch from the first mode to a second mode and continue the playback of the target video in the second mode in response to detecting a preset condition; where in the second mode the interface elements are not displayed in the video playback interface; and
a custom component display module, configured to display a mode exit control and at least one custom component corresponding to the target object in an edge region of the video playback interface; where the custom component is used for displaying extended information of the target object and/or an attribution party of the target object, and the extended information is information other than the video content.

In a third aspect, an embodiment of the present disclosure further provides an electronic device, and the electronic device includes:
at least one processor; and
at least one memory, configured to store executable instructions;
   where the processor is configured to read the executable instructions from the at least one memory and execute the executable instructions to implement the video playback method described in any embodiment of the present disclosure.

In a fourth aspect, an embodiment of the present disclosure further provides a computer-readable storage medium, where the storage medium stores a computer program, and the computer program, when executed by at least one processor, causes the at least one processor to implement the video playback method described in any embodiment of the present disclosure.

In a fifth aspect, an embodiment of the present disclosure further provides a computer program product, and the computer program product is used for performing the video playback method described in any embodiment of the present disclosure.

It should be noted that the user information (including but not limited to user device information, user personal information, etc.) and data (including but not limited to data for analysis, stored data, displayed data, etc.) involved in the embodiments of the present disclosure are information and data authorized by the user or fully authorized by all parties, and the collection, use and processing of the related data need to comply with the related laws, regulations and standards of the related countries and regions, and a corresponding operation entry is provided for the user to choose authorization or rejection.

### BRIEF DESCRIPTION OF THE DRAWINGS

The above and other features, advantages and aspects of various embodiments of the present disclosure will become more apparent when taken in conjunction with the drawings and with reference to the following detailed description. Throughout the drawings, the same or similar reference numbers refer to the same or similar elements. It should be understood that the drawings are schematic and that the elements and components are not necessarily drawn to scale.

FIG. 1 is a schematic diagram of display of a video playback interface in a first mode according to an embodiment of the present disclosure;

FIG. 2 is a schematic flowchart of a video playback method according to an embodiment of the present disclosure;

FIG. 3 is a schematic diagram of display of a video playback interface in a second mode according to an embodiment of the present disclosure;

FIG. 4 is a schematic flowchart of another video playback method according to an embodiment of the present disclosure;

FIG. 5 is a schematic diagram of display of a preset animation in an early stage according to an embodiment of the present disclosure;

FIG. 6 is a schematic diagram of display of a preset animation in a later stage according to an embodiment of the present disclosure;

FIG. 7 is a schematic structural diagram of a video playback apparatus according to an embodiment of the present disclosure; and

FIG. 8 is a schematic structural diagram of an electronic device according to an embodiment of the present disclosure.

### DETAILED DESCRIPTION OF EMBODIMENTS

Embodiments of the present disclosure will be described in more detail below with reference to the drawings. Although certain embodiments of the present disclosure are shown in the drawings, it should be understood that the present disclosure may be implemented in various forms and should not be construed as limited to the embodiments set forth herein. Instead, these embodiments are provided for a more thorough and complete understanding of the present disclosure. It should be understood that the drawings and embodiments of the present disclosure are only for illustrative purposes, and are not intended to limit the protection scope of the present disclosure.

It should be understood that the various steps described in the method implementations of the present disclosure may be performed in different orders and/or in parallel. Furthermore, the method implementations may include additional steps and/or omit the execution of the steps shown. The scope of the present disclosure will not be limited in this regard.

The term “include/comprise” and its variants used herein are open-ended inclusions, that is, “include/comprise but not limited to”. The term “based on” is “at least partially based on”. The term “one embodiment” means “at least one embodiment”; the term “another embodiment” means “at least one other embodiment”; the term “some embodiments” means “at least some embodiments”. Related definitions of other terms will be given in the following description.

It should be noted that concepts such as “first” and “second” mentioned in the present disclosure are only used to distinguish different apparatuses, modules or units, and are not used to limit the order or interdependence of the functions performed by these apparatuses, modules or units.

It should be noted that the modifications of “one” and “multiple” mentioned in the present disclosure are illustrative rather than restrictive, and those skilled in the art should understand that they should be understood as “one or multiple” unless otherwise clearly indicated in the context.

The names of messages or information exchanged between multiple apparatuses in the implementations of the present disclosure are only used for illustrative purposes, and are not used to limit the scope of these messages or information.

With various types of videos becoming more and more popular, there are cases where a certain object (such as a physical product, a virtual service, a supplier that provides products/services, etc.) is promoted or recommended through a video. This type of video has a high requirement for the visibility of video content/video material. However, in the process of playing a video, a current video player will display some permanent interface elements launched by a video platform in a video playback interface, such as an interactive control with an interactive function, publisher information, etc., and these interface elements will cover part of the video content, which affects the visibility of the video content, and prevents a user from better obtaining information about a recommended object, resulting in a low playback rate of this type of video and a poor promotion effect of the recommended object.

According to the video playback method, the apparatus, the device, the storage medium and the program product of the embodiments of the present disclosure, the target video including the target object may be played in the video playback interface in the first mode in response to the triggering operation on the target video; in the first mode the interface elements irrelevant to the video content of the target video are displayed in the video playback interface; the first mode is switched to the second mode and the target video continues to be played in the second mode in response to detecting the preset condition; in the second mode the interface elements are not displayed in the video playback interface; and the mode exit control and the at least one custom component corresponding to the target object are displayed in the edge region of the video playback interface; the custom component is used for displaying the extended information of the target object and/or the attribution party of the target object, and the extended information is information other than the video content. In this way, it is switched to the second mode where the irrelevant interface elements are hidden to play the target video in the process of playing the video, which reduces the shielding of the video content by these interface elements, so that the user may watch the video content more completely and immersively, and the efficiency of obtaining video information is improved, thereby increasing the playback rate of the target video and the promotion effect of the recommended object. Moreover, in the second mode, more extended information related to the target object in the target video is additionally displayed through the custom component, which provides a higher information customization space for the attribution party corresponding to the target object, thereby enriching the information related to the target object in the target video, further improving the immersion of the user in watching the target video and the efficiency of the user in obtaining the information related to the target object, and in turn further improving the completion rate of the target video and the promotion effect of the target video on the recommended object.

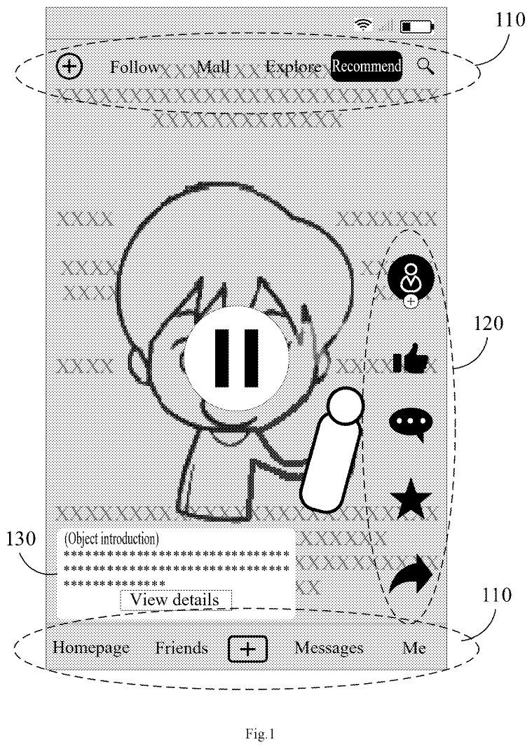

While presenting video content, a video playback interface in the related art will display some permanent interface elements. Referring to FIG. 1, in the video playback interface, navigation-type controls 110 for functional navigation are displayed in an upper edge region and a lower edge region, interactive controls 120 with interactive functions such as liking, commenting, sharing, etc. are displayed in a right edge region, an object introduction card 130 of a recommended object involved in the video content is displayed in a lower region, and so on. These interface elements are useless for the user to have an in-depth understanding of the video content, but will cover the video image or the text in the video, etc., so that the user cannot browse the video content completely and immersively, which affects the playback rate of the video, and the promotion effect and conversion rate of the recommended object.

Based on the above situation, an embodiment of the present disclosure provides a video playback solution, which implements clearing the screen in the process of playing a video, achieves an immersive video playback effect without related interface elements, and may add some custom components in the second mode to display more information related to the recommended object, further increasing the information content of the recommended object in the video, thereby increasing the video playback rate, and the promotion effect and conversion rate of the recommended object.

The video playback method provided by the embodiment of the present disclosure is applicable to a playback scenario of a recommendation-type video. The method may be executed by a video playback apparatus, and the apparatus may be implemented by software and/or hardware, and the apparatus may be integrated in an electronic device with a video playback function. The electronic device may include, but is not limited to, a smartphone, a personal digital assistant (PDA), a tablet personal computer (Tablet PC), a wearable device, a portable media player (PMP), a vehicle-mounted terminal (such as a vehicle navigation terminal), a notebook computer, or a desktop computer, etc.

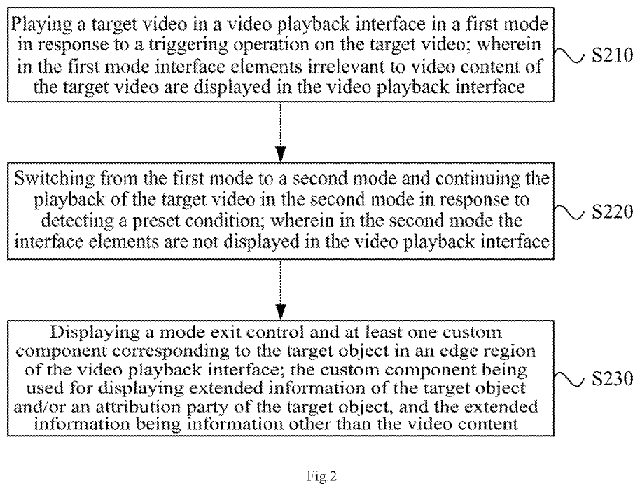

FIG. 2 is a schematic flowchart of a video playback method according to an embodiment of the present disclosure. As shown in FIG. 2, the video playback method may include the following steps.
S210: playing a target video in a video playback interface in a first mode in response to a triggering operation on the target video; where in the first mode interface elements irrelevant to video content of the target video are displayed in the video playback interface.

The target video is a to-be-played video, which includes at least one object (that is, the target object) to be recommended to the user. For example, the target video may be a pre-produced advertisement video of the target object. The target object here may be a physical item, a virtual item, a service, an attribution party (such as a brand party or a supplier) of the item/service, and so on. The interface elements cover various visual elements that the user sees in the process of interacting with the software or application, and may accurately refer to various components that do not belong to the video content itself but belong to the video playback interface. The interface elements irrelevant to the video content in the embodiments of the present disclosure may include, for example, but are not limited to, an advertisement mask, an advertisement card, a control element, etc., and the control element may include an avatar of a publisher of the video, comments, sharing, likes, permanent functional navigation controls at the top and bottom, and so on.

Specifically, the user may perform the triggering operation of the target video on the electronic device. For example, when the electronic device presents many videos in the form of a video stream, the user switches the video to the target video; or, the electronic device presents recommendation information, and the recommendation information includes the target video, and the user performs an operation of starting or playing the target video in the recommendation information; or, a search result displayed after the user performs a search operation includes the target video, and the user performs an operation of starting or playing the target video, and so on. When detecting the above triggering operation, the electronic device may use the current page or a new page as the video playback interface, and start playing the target video in the first mode as shown in FIG. 1.
S220: switching from the first mode to a second mode and continuing the playback of the target video in the second mode in response to detecting a preset condition; where in the second mode the above interface elements are not displayed in the video playback interface.

The preset condition is a condition that may trigger to start the second mode (also referred to as an immersive mode or a screen clearing mode) of video playback, for example, the video playback time reaches a certain duration, the user performs an interaction operation on the video playback interface or the interface elements displayed therein, and so on.

Specifically, in order to improve the flexibility of video playback, the first mode and the second mode are preset, and a corresponding implementation condition is configured for the switching of the playback mode, where starting the second mode corresponds to the preset condition. Therefore, after starting playback of the target video, the electronic device starts to detect whether the preset condition is reached. If the preset condition is detected, the first mode is switched to the second mode, and the target video continues to be played in the second mode. That is, after detecting the preset condition, in the process of continuing the playback of the target video, the electronic device hides the navigation-type controls 110 displayed in the upper edge region and the lower edge region, the interactive controls 120 displayed in the right edge region, and the object introduction card 130 displayed in the lower region in FIG. 1, so as to present the complete video content in a full screen and interference-free manner.

In some embodiments, the switching from the first mode to the second mode in response to detecting the preset condition may be implemented as follows: the electronic device presents interaction operation guidance information in the form of animation, and after detecting that the user performs a corresponding interaction operation, the first mode is switched to the second mode.

In some other embodiments, the switching from the first mode to the second mode in response to detecting the preset condition includes: switching from the first mode to the second mode in response to a second interaction operation on the video playback interface. The second interaction operation is a preset interaction operation that may trigger to start the second mode, for example, a click or double-click triggering operation on the video playback interface, a preset interaction gesture, a preset interaction voice instruction, and so on. Therefore, after detecting the second interaction operation performed by the user on the video playback interface, the electronic device may switch to the second mode. This may reduce the number of irrelevant interface elements in the video playback interface, thereby reducing the shielding and interference of the video content to a certain extent, and improving the convenience of starting the second mode.

In some other embodiments, the switching from the first mode to the second mode in response to detecting the preset condition includes: switching from the first mode to the second mode in response to a triggering operation on a mode switching control displayed in the video playback interface. The mode switching control is an interactive control that may trigger the switching to the second mode, for example, a button or the like that presents a text label such as “switch to the second mode” and “clear the screen”. Therefore, the user performs the triggering operation on the mode switching control displayed in the video playback interface, and the switching to the second mode may be performed. This may be compatible with the existing interface interaction modes.

In some other embodiments, the switching from the first mode to the second mode in response to detecting the preset condition includes: switching from the first mode to the second mode in response to a playback duration of the target video reaching a second preset duration. The second preset duration is a preset relatively long playback duration, which may be determined according to behavior data of many users browsing recommendation-type videos. For example, the average duration of most users browsing recommendation-type videos is 5 seconds or 7 seconds and it may be set as the second preset duration. In this way, when the target video is played to the playback progress of the second preset duration, the electronic device may automatically switch the first mode to the second mode to attract the user to continue watching the target video, thereby increasing the playback rate of the target video to a certain extent.
S230: displaying a mode exit control and at least one custom component corresponding to the target object in an edge region of the video playback interface; where the custom component is used for displaying extended information of the target object and/or an attribution party of the target object, and the extended information is information other than the video content.

The mode exit control is an interactive control used for exiting the second mode. The custom component is a visual component customized by the attribution party corresponding to the target object as needed, for example, a visual card, a text control carrying pictures and texts, and so on.

Specifically, after the electronic device starts the second mode, the video playback interface basically presents the complete video content without other information. In this case, the electronic device may add some custom components customized by the attribution party in the edge region to supplement more information of the target object and/or its corresponding attribution party on the basis of the video content, so that the user may have a deeper understanding of the target object or its attribution party, and the playback immersion of the target video may be further improved, thereby increasing the completion rate of the target video and the promotion effect of the target video on the target object or its attribution party.

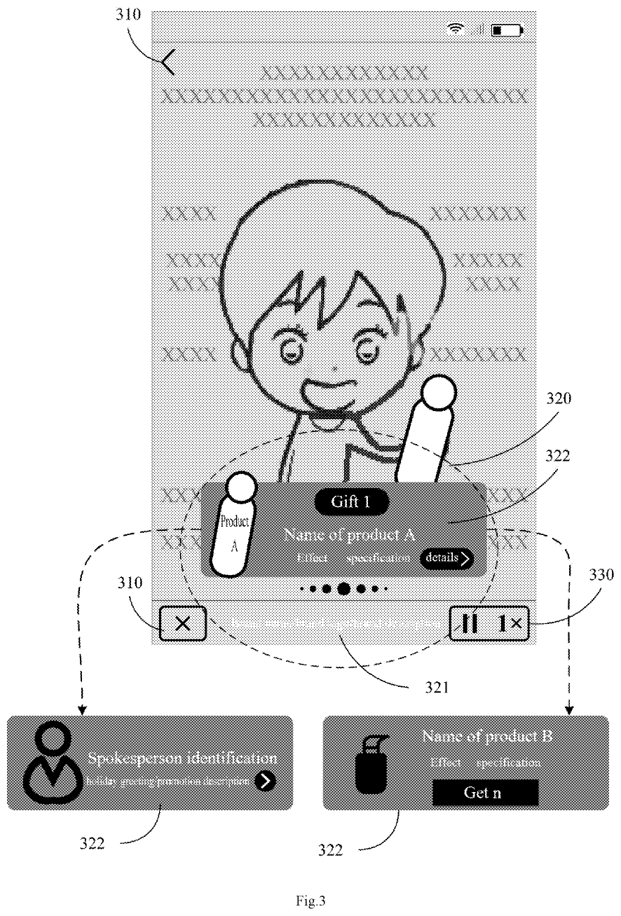

Referring to FIG. 3, in the second mode, the electronic device may display continuously played video content in the video playback interface, and display a mode exit control 310 and at least one custom component 320 in the edge region of the video playback interface. In addition, in order to conveniently control the video playback, the electronic device may further display a playback control component 330 (such as a multiple-speed control, a pause control, etc.) in the edge region of the video playback interface.

The above custom component may be generated by a user corresponding to the attribution party filling in content such as custom pictures, texts, jump links, animations, etc. according to the component template provided by the video platform during the production process of the target video, or may be a completely customized component (such as a custom interactive pendant/entry control of an interactive task, etc.) that has been produced and uploaded by the user corresponding to the attribution party according to the requirements of the custom component provided by the video platform. In this way, more customization space may be provided for the attribution party corresponding to the target object, so that the target video may more flexibly convey the information that the attribution party wants to promote to a user, and the rights and interests of the attribution party may be further improved.

In some embodiments, the displaying at least one custom component in the edge region of the video playback interface includes: displaying a first information component of the attribution party in a bottom edge region of the video playback interface; and displaying at least one custom information card in an upper adjacent region of the bottom edge region.

The first information component is a visual component used for transmitting overall information related to the attribution party. In an embodiment of the present disclosure, the first information component carries at least one of an attribution party identification image (such as a brand logo), an attribution party identification text (such as a brand name, an abbreviation, etc.) or a preset attribution party description. The preset attribution party description is preset information used for representing information to be transparently transmitted by the attribution party in a certain period of time or as a whole, for example, it may be a promotional phrase/slogan that displays a specific promotion during holidays, or it may be a simplified brand promotional phrase extracted from the perspective of the value concept/social mission/brand spirit of the attribution party, and so on. The first information component may be set as an information display component without an interaction function.

The custom information card is a visual card that defines the card display content by itself, and is used for displaying detailed information of the attribution party in a certain vertical dimension. The custom information card in the embodiment of the present disclosure includes an object introduction card of a product object provided by the attribution party (such as a display card of introduction information of any product launched by a certain brand), an object introduction card of the target object (such as a display card of introduction information of the target object in any efficacy/specification), a proxy card corresponding to the attribution party (such as a display card containing information such as an image/avatar, a promotional phrase or a holiday greeting of a brand spokesperson), an object conversion card of the product object (such as a display card containing a text label of “get/buy immediately” and pointing to an order page of the product object), an object conversion card of the target object (such as a display card containing a text label of “get/buy immediately” and pointing to an order page of the target object of a certain specification/preference), an interactive task card corresponding to the target object (such as a display card pointing to an interactive play/task related to the target object) or an interactive task card corresponding to the attribution party (such as a display card pointing to an interactive play/task related to the brand). The custom information card may be set as a visual card that has an interaction function and points to a certain link.

Specifically, still referring to FIG. 3, the electronic device may display the first information component 321 of the attribution party in the bottom edge region of the video playback interface in the second mode, so as to reveal the relevant information of the attribution party corresponding to the target object as a whole. Moreover, at least one custom information card 322 may be displayed in the display region (referred to as the upper adjacent region for short) above and adjacent to the bottom edge region. In this way, the overall static information may be presented through the first information component, and the information in the interactive subdivision dimension may be presented through the at least one custom information card, so that more relevant information of the target object/attribution party may be presented from different angles and different levels, and the immersion of video playback, and the integrity and in-depth of information transmission may be further improved.

It should be noted that the card size of the custom information card may be set according to the video content. For example, when the presented video content covers a larger area of the video playback interface, the size of the custom information card may be set to a relatively small size, so as to reduce the shielding of the video content as much as possible while displaying the extended information; while when the presented video content covers a smaller area of the video playback interface, the size of the custom information card may be set to a relatively larger size, so as to fully display the extended information without shielding the video content as much as possible.

It may be understood that because the custom information card also presents the relevant information of the target object/attribution party, even if it slightly shields the video content, its impact on the user's acquisition of the information of the target object/attribution party is negligible compared with the additionally displayed extended information.

In some embodiments, the displaying at least one custom information card in the upper adjacent region of the bottom edge region includes: dynamically and circularly displaying the respective custom information cards in the upper adjacent region. Still referring to FIG. 3, when there are multiple custom information cards, the electronic device may dynamically display the respective custom information cards in a carousel manner with the video playback progress. When the user is interested in the content displayed in a certain custom information card, the user may directly trigger the interaction with the custom information card, and the user may browse multiple pieces of extended information without excessive interaction, thus the efficiency of information display may be improved to a certain extent.

In some other embodiments, the displaying at least one custom information card in the upper adjacent region of the bottom edge region includes: flatly displaying the respective custom information cards in the upper adjacent region according to a preset direction. When there are multiple custom information cards, the electronic device may display multiple custom information cards of a relatively small size flatly, so that the user may browse multiple pieces of extended information at one time, and the efficiency of obtaining the extended information may be improved.

In some other embodiments, the displaying at least one custom information card in the upper adjacent region of the bottom edge region includes: aggregately displaying the respective custom information cards in the upper adjacent region in the form of a collection. When there are multiple custom information cards, the electronic device may display the respective custom information cards in an aggregate manner in a form similar to an album, so as to prompt the user that there are multiple custom information cards through one card occupancy, thereby further reducing the shielding of the video content by the extended information.

In some other embodiments, the displaying at least one custom information card in the upper adjacent region of the bottom edge region includes: in response to a switching operation on the custom information card currently displayed in the upper adjacent region, displaying a next custom information card in the upper adjacent region. When there are multiple custom information cards, the electronic device may present the multiple custom information cards in parallel, and provide a card switching function such as sliding switching or gesture switching, so that the user may browse each piece of extended information through the switching operation on the respective custom information cards.

According to the video playback method provided by the above embodiments of the present disclosure, the target video including the target object may be played in the video playback interface in the first mode in response to the triggering operation on the target video; in the first mode the interface elements irrelevant to the video content of the target video are displayed in the video playback interface; the first mode is switched to the second mode and the target video continues to be played in the second mode in response to detecting the preset condition; in the second mode the interface elements are hidden; and the mode exit control and the at least one custom component corresponding to the target object are displayed in the edge region of the video playback interface; the custom component is used for displaying the extended information of the target object and/or the attribution party of the target object, and the extended information is information other than the video content. In this way, it is switched to the second mode where the irrelevant interface elements are hidden to play the target video in the process of playing the video, which reduces the shielding of the video content by these interface elements, so that the user may watch the video content more completely and immersively, and the efficiency of obtaining video information is improved, thereby increasing the playback rate of the target video and the promotion effect of the recommended object. Moreover, in the second mode, more extended information related to the target object in the target video is additionally displayed through the custom component, which provides a higher information customization space for the attribution party corresponding to the target object, thereby enriching the information related to the target object in the target video, further improving the immersion of the user in watching the target video and the efficiency of the user in obtaining the information related to the target object, and in turn further improving the completion rate of the target video and the promotion effect of the target video on the recommended object.

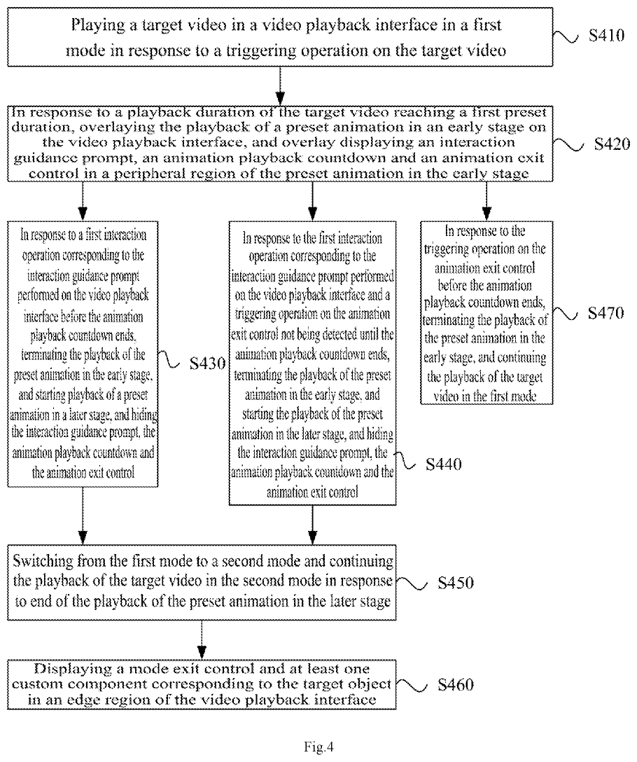

FIG. 4 is a schematic flowchart of another video playback method according to an embodiment of the present disclosure. On the basis of the above embodiments, the video playback method further details the “switching from the first mode to the second mode in response to detecting the preset condition”. Referring to FIG. 4, the video playback method specifically includes the following steps.
S410: playing a target video in a video playback interface in a first mode in response to a triggering operation on the target video.
S420: in response to a playback duration of the target video reaching a first preset duration, overlaying the playback of a preset animation in an early stage on the video playback interface, and overlay displaying an interaction guidance prompt, an animation playback countdown and an animation exit control in a peripheral region of the preset animation in the early stage.

The first preset duration is another preset duration, which is a relatively short duration, such as 1 second to 3 seconds. The preset animation is a pre-produced animation with an interaction function, which may be divided into an early stage and a later stage to respectively represent that the second mode is not triggered to start and that the second mode is triggered to start, and the animation conversion between the early stage and the later stage is triggered by an interaction operation. The preset animation may include an animation element (referred to as an associated animation element for short) related to the target object/attribution party, for example, the preset animation may be a gift box opening animation including an image of the target object/product object, the preset animation in the early stage is an animation of the gift box not being opened, and the preset animation in the later stage is an animation of the gift box being opened; the preset animation may also not include the associated animation element, for example, it may be a screen wiping animation, a firework animation, and so on, the preset animation in the early stage is an animation of not starting the wiping action or lighting the firework, and the preset animation in the later stage is an animation of starting the wiping action or the firework exploding. The interaction guidance prompt is prompt information for guiding the user's interaction operation, which may be in a text form or a picture form. The animation playback countdown is information that represents the animation display time. The animation exit control is an interactive control that triggers to terminate the animation.

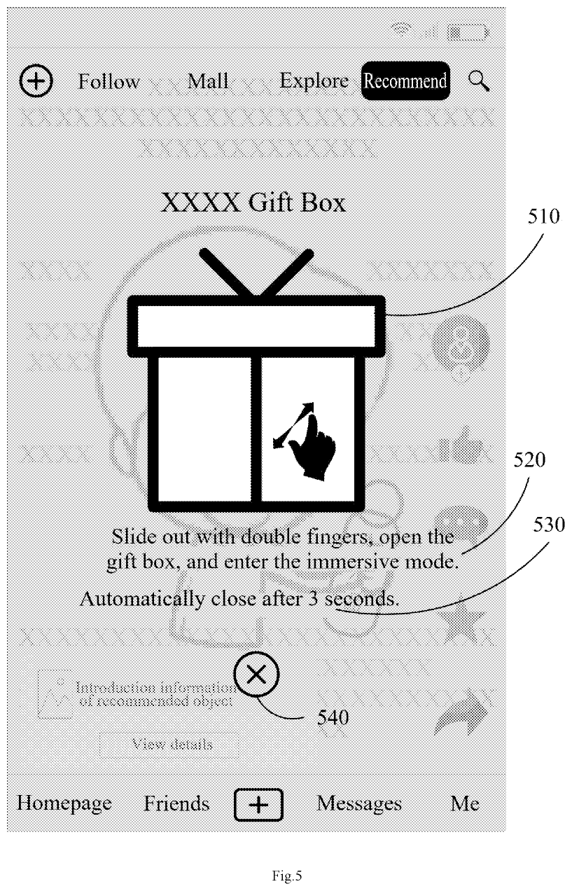

Specifically, referring to FIG. 5, after the playback duration of the target video reaches the first preset duration, in order to guide the user to perform the screen clearing interaction operation more vividly and interestingly, the electronic device may overlay play the preset animation 510 in the early stage on the video playback interface. The preset animation in the early stage may be an animation of the gift box not being opened, and may include an animation of expanding with two fingers to prompt the interaction mode in a visual form. Moreover, the interaction guidance prompt 520 (such as a prompt text “slide out with double fingers, open the gift box, and enter the second mode”) may be overlay displayed in the peripheral region of the preset animation to prompt the interaction mode in the text form. In addition, the animation playback countdown 530 and the animation exit control 540 may also be displayed.
S430: in response to a first interaction operation corresponding to the interaction guidance prompt performed on the video playback interface before the animation playback countdown ends, terminating the playback of the preset animation in the early stage, and starting playback of a preset animation in a later stage, and hiding the interaction guidance prompt, the animation playback countdown and the animation exit control.

Specifically, if before the animation playback countdown ends, the electronic device detects that the user performs the corresponding first interaction operation according to the interaction guidance prompt, such as an interaction operation of sliding out with two fingers simultaneously on the screen, the electronic device may terminate playing the preset animation in the early stage, and start playing the preset animation in the later stage. The preset animation in the later stage may be an animation of the gift box being opened. In the process of playing the preset animation in the later stage, because the user has already performed the animation switching interaction operation, the user may no longer exit the animation, so there is no need to display the animation playback countdown 530 and the animation exit control 540, and thus the hiding processing is performed on them.

In some embodiments, the preset animation in the later stage includes an associated animation element related to the target object. When the user performs the first interaction operation, in addition to that the preset animation in the later stage can be started, it also represents that the user triggers the switching function of the second mode, and the second mode is subsequently entered. In this case, the associated animation element related to the target object may be added to the preset animation in the later stage, which may further increase the display stage of the extended information, thereby further enriching the information related to the target object/attribution party. The associated animation element may be an animation element presented statically for display only; or it may be an animation element presented dynamically to add interest while displaying.
S440: in response to the first interaction operation corresponding to the interaction guidance prompt performed on the video playback interface and a triggering operation on the animation exit control not being detected until the animation playback countdown ends, terminating the playback of the preset animation in the early stage, and starting playback of the preset animation in the later stage, and hiding the interaction guidance prompt, the animation playback countdown and the animation exit control.

Specifically, if the preset animation in the early stage is played until the animation playback countdown ends, the electronic device still does not detect that the user performs the first interaction operation, and does not detect the triggering operation of the user on the animation exit control, it may be considered that the user switches to the second mode by default. At this time, the electronic device may also terminate playing the preset animation in the early stage, and start playing the preset animation in the later stage to start the switching function of the second mode.
S450: switching from the first mode to the second mode and continuing playback of the target video in the second mode in response to end of playback of the preset animation in the later stage.

Specifically, if the electronic device monitors that the preset animation in the later stage ends playing, it indicates that the interaction process of playback mode switching is completed. At this time, the second mode may be switched to, and the target video continues to be played in the second mode.
S460: displaying a mode exit control and at least one custom component corresponding to the target object in an edge region of the video playback interface.

In some embodiments, a moving start point and a moving end point of the associated animation element respectively correspond to an animation range of the preset animation in the later stage and the edge region of the video playback interface, and the custom component displayed first in the edge region includes the associated animation element.

Specifically, in order to further increase the linkage between the preset animation and the custom component displayed in the second mode, thereby further enhancing the interest of video playback, the associated animation element in the later stage may be set in a dynamic presentation manner with a certain moving path, and the moving start point of the moving path is within the animation range of the preset animation in the later stage (such as the center position of the preset animation, or the animation edge position close to the edge region of the video playback interface where the custom component is subsequently displayed), and the moving end point of the moving path is in the edge region of the video playback interface where the custom component is subsequently displayed. Meanwhile, the above associated animation element may be displayed in the custom component displayed first in the second mode.

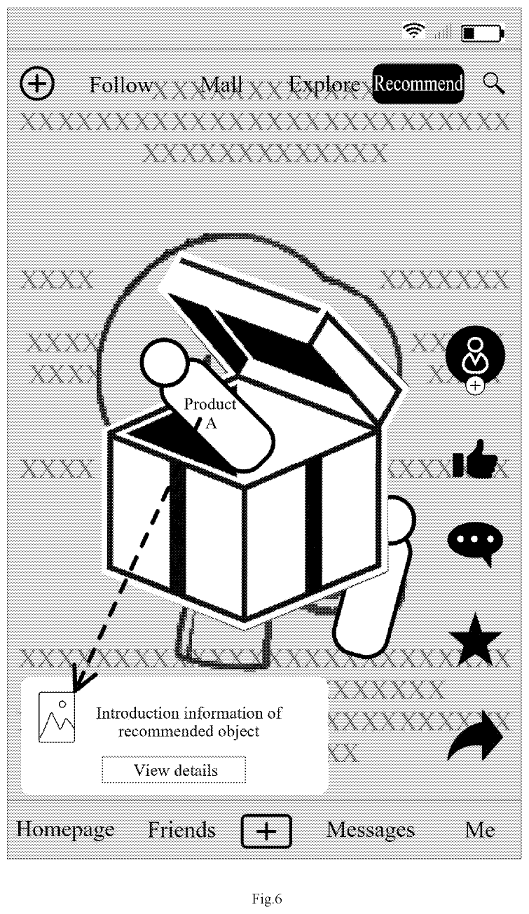

For example, after the user performs the first interaction operation according to the preset animation in the early stage as shown in FIG. 5, the electronic device may display the preset animation in the later stage as shown in FIG. 6, and display the associated animation element of “Product A” therein. In the process of playing the preset animation in the later stage, the associated animation element appears from the moving start point of the gift box element, and starts to move according to the predetermined moving path until the preset animation in the later stage ends playing and moves to the moving end point of the custom component displayed first. Then, the video playback interface in the second mode as shown in FIG. 3 is presented immediately, and the custom information card corresponding to “Product A” is displayed first.
S470: in response to the triggering operation on the animation exit control before the animation playback countdown ends, terminating the playback of the preset animation in the early stage, and continuing the playback of the target video in the first mode.

Specifically, if the user triggers the animation exit control before the animation playback countdown of the preset animation in the early stage ends, it may be considered that the user does not want to watch the preset animation and also does not want to switch to the second mode. Therefore, the electronic device may terminate the preset animation in the early stage and continue the playback of the target video in the first mode in response to the triggering operation.

According to the video playback method provided by the above embodiments of the present disclosure, the preset animation in the early stage can be overlay played on the video playback interface in response to the playback duration of the target video reaching the first preset duration, and the interaction guidance prompt, the animation playback countdown and the animation exit control can be overly displayed in the peripheral region of the preset animation in the early stage; the preset animation in the early stage is terminated being played and the preset animation in the later stage is started being played in response to the first interaction operation corresponding to the interaction guidance prompt performed on the video playback interface before the animation playback countdown ends, or in response to the first interaction operation and the triggering operation on the animation exit control not being detected until the animation playback countdown ends, and the interaction guidance prompt, the animation playback countdown and the animation exit control are hidden; the first mode is switched to the second mode in response to end of the playback of the preset animation in the later stage. In this way, the user is guided to perform the interaction mode of playing mode switching with the preset animation, which improves the interest of interaction guidance, thereby reducing the user's cognitive/understanding cost for the interaction operation of playing mode switching, increasing the possibility of the user switching to the second mode, and in turn further improving the playing rate of the target video and the promotion effect of the target video on the target object.

The following is an embodiment of a video playback apparatus provided by an embodiment of the present disclosure, and the apparatus belongs to the same inventive concept as the video playback method of the above embodiments. For details not described in detail in the embodiment of the video playback apparatus, reference may be made to the embodiment of the above video playback method.

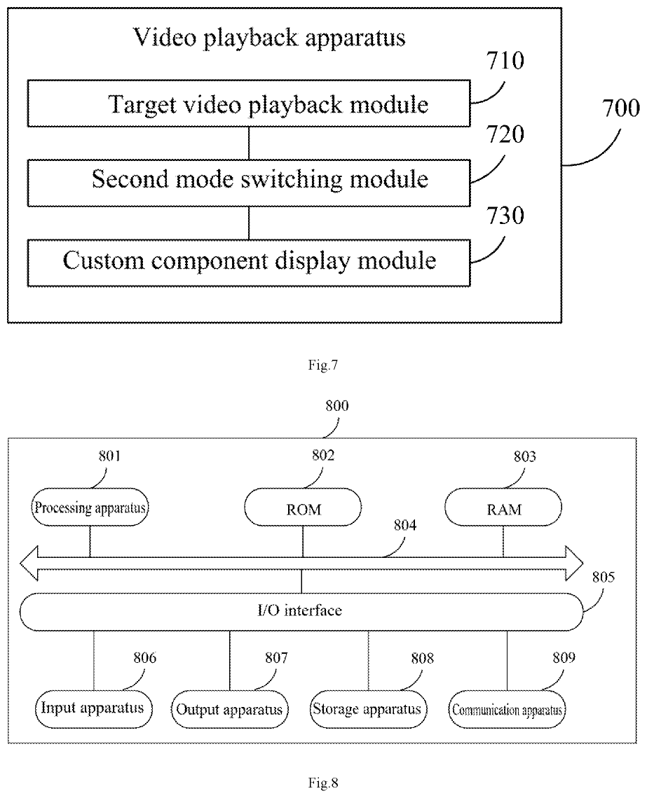

FIG. 7 is a schematic structural diagram of a video playback apparatus provided by an embodiment of the present disclosure. As shown in FIG. 7, the video playback apparatus 700 may include:
a target video playback module 710, configured to play a target video in a video playback interface in a first mode in response to a triggering operation on the target video; where the target video includes at least a target object; and in the first mode interface elements irrelevant to video content of the target video are displayed in the video playback interface;
a second mode switching module 720, configured to switch from the first mode to a second mode and continue the playback of the target video in the second mode in response to detecting a preset condition; where in the second mode the interface elements are not displayed in the video playback interface; and
a custom component display module 730, configured to display a mode exit control and at least one custom component corresponding to the target object in an edge region of the video playback interface; where the custom component is used for displaying extended information of the target object and/or an attribution party of the target object, and the extended information is information other than the video content.

The video playback apparatus provided by the embodiment of the present disclosure may play the target video in the video playback interface in the first mode in response to the triggering operation on the target video including the target object; in the first mode the interface elements irrelevant to the video content of the target video are displayed in the video playback interface; the first mode is switched to the second mode and the target video continues to be played in the second mode in response to detecting the preset condition; in the second mode the interface elements are hidden; and the mode exit control and the at least one custom component corresponding to the target object are displayed in the edge region of the video playback interface; the custom component is used for displaying the extended information of the target object and/or the attribution party of the target object, and the extended information is information other than the video content. In this way, it is switched to the second mode where the irrelevant interface elements are hidden to play the target video in the process of playing the video, which reduces the shielding of the video content by these interface elements, so that the user may watch the video content more completely and immersively, and the efficiency of obtaining video information is improved, thereby increasing the playing rate of the target video and the promotion effect of the recommended object. Moreover, in the second mode, more extended information related to the target object in the target video is additionally displayed through the custom component, which provides a higher information customization space for the attribution party corresponding to the target object, thereby enriching the information related to the target object in the target video, further improving the immersion of the user in watching the target video and the efficiency of the user in obtaining the information related to the target object, and in turn further improving the completion rate of the target video and the promotion effect of the target video on the recommended object.

In some embodiments, the custom component display module 730 includes:
a first information component display sub-module, configured to display a first information component of the attribution party in a bottom edge region of the video playback interface; where the first information component carries at least one of an attribution party identification image, an attribution party identification text or a preset attribution party description; and
a custom information card display sub-module, configured to display at least one custom information card in an upper adjacent region of the bottom edge region; where the custom information card includes an object introduction card of a product object provided by the attribution party, an object introduction card of the target object, a proxy card corresponding to the attribution party, an object conversion card of the product object, an object conversion card of the target object, an interactive task card corresponding to the target object, or an interactive task card corresponding to the attribution party.

In some embodiments, the second mode switching module 720 is further configured to:
in response to a playback duration of the target video reaching a first preset duration, overlay play a preset animation in an early stage on the video playback interface, and overlay and display an interaction guidance prompt, an animation playback countdown and an animation exit control in a peripheral region of the preset animation in the early stage; and
in response to a first interaction operation corresponding to the interaction guidance prompt performed on the video playback interface before the animation playback countdown ends, or in response to the first interaction operation and a triggering operation on the animation exit control not being detected until the animation playback countdown ends, terminate playing the preset animation in the early stage, and start playing a preset animation in a later stage, and hide the interaction guidance prompt, the animation playback countdown and the animation exit control; and
in response to end of the playback of the preset animation in the later stage, switch from the first mode to the second mode.

In some embodiments, the preset animation in the later stage includes an associated animation element related to the target object.

In some embodiments, a moving start point and a moving end point of the associated animation element respectively correspond to an animation range of the preset animation in the later stage and the edge region, and the custom component displayed first in the edge region includes the associated animation element.

In some embodiments, the second mode switching module 720 is further configured to:
after overlaying the playback of the preset animation in the early stage on the video playback interface and overlay displaying the interaction guidance prompt, the animation playback countdown and the animation exit control in the peripheral region of the preset animation in the early stage in response to the playback duration of the target video reaching the first preset duration, terminate playing the preset animation in the early stage and continue the playback of the target video in the first mode in response to the triggering operation on the animation exit control before the animation playback countdown ends.

In some embodiments, the second mode switching module 720 is further configured to:
switch from the first mode to the second mode in response to the playback duration of the target video reaching a second preset duration;
or, switch from the first mode to the second mode in response to a second interaction operation on the video playback interface;
or, switch from the first mode to the second mode in response to a triggering operation on a mode switching control displayed in the video playback interface.

In some embodiments, the custom information card display sub-module is further configured to display the at least one custom information card in the upper adjacent region of the bottom edge region by any of the following:
dynamically and circularly displaying the respective custom information cards in the upper adjacent region;
flatly displaying the respective custom information cards in the upper adjacent region according to the preset direction;
aggregately displaying the respective custom information cards in the upper adjacent region in the form of a collection; and
in response to the switching operation on the custom information card currently displayed in the upper adjacent region, displaying a next custom information card in the upper adjacent region.

The video playback apparatus provided by the embodiment of the present disclosure may execute the video playback method provided by any embodiment of the present disclosure, and has corresponding functional modules for executing the method and beneficial effects.

It is worth noting that in the above embodiment of the video playback apparatus, each of the included units and modules are only divided according to functional logic, but are not limited to the above division, as long as the corresponding functions may be realized; in addition, the specific names of the functional units are only for the convenience of distinguishing from each other, and are not used to limit the protection scope of the present disclosure.

An embodiment of the present disclosure further provides an electronic device, and the electronic device may include a processor and a memory, and the memory may be configured to store executable instructions. The processor may be configured to read the executable instructions from the memory and execute the executable instructions to implement the video playback method in the above embodiments.

FIG. 8 is a schematic structural diagram of an electronic device provided by an embodiment of the present disclosure.

As shown in FIG. 8, the electronic device 800 may include a processing apparatus 801 (such as a central processing unit, a graphics processor, etc.), which may perform various appropriate actions and processes according to a program stored in a read-only memory (ROM) 802 or a program loaded from a storage apparatus 808 into a random access memory (RAM) 803. The RAM 803 further stores various programs and data required for the operation of the electronic device 800. The processing apparatus 801, the ROM 802 and the RAM 803 are connected to each other through a bus 804. An input/output interface (I/O interface) 805 is also connected to the bus 804.

Usually, the following apparatuses may be connected to the I/O interface 805: an input apparatus 806 including, for example, a touch screen, a touchpad, a keyboard, a mouse, a camera, a microphone, an accelerometer, a gyroscope, etc.; an output apparatus 807 including, for example, a liquid crystal display (LCD), a speaker, a vibrator, etc.; the storage apparatus 808 including, for example, a magnetic tape, a hard disk, etc.; and a communication apparatus 809. The communication apparatus 809 may allow the electronic device 800 to perform wireless or wired communication with other devices to exchange data.

It should be noted that the electronic device 800 shown in FIG. 8 is only an example, and should not bring any limitation to the function and scope of use of the embodiments of the present disclosure. That is, although FIG. 8 shows the electronic device 800 having various apparatuses, it should be understood that it is not required to implement or have all the apparatuses shown. Alternatively, more or fewer apparatuses may be implemented or provided.

In particular, according to the embodiments of the present disclosure, the process described above with reference to the flowchart may be implemented as a computer software program. For example, the embodiments of the present disclosure include a computer program product, which includes a computer program carried on a non-transitory computer-readable medium, and the computer program includes program code for executing the method shown in the flowchart. In such an embodiment, the computer program may be downloaded and installed from a network through the communication apparatus 809, or installed from the storage apparatus 808, or installed from the ROM 802. When the computer program is executed by the processing apparatus 801, the above functions defined in the network isolation policy management method of any embodiment of the present disclosure are executed.

An embodiment of the present disclosure further provides a computer-readable storage medium, where the storage medium stores a computer program, and the computer program, when executed by a processor, causes the processor to implement the network isolation policy management method in any embodiment of the present disclosure.

It should be noted that the above computer-readable medium in the present disclosure may be a computer-readable signal medium, a computer-readable storage medium, or any combination of the two. The computer-readable storage medium may be, for example, but is not limited to, an electronic, magnetic, optical, electromagnetic, infrared, or semiconductor system, apparatus or device, or any combination of the above. More specific examples of the computer-readable storage medium may include, but are not limited to: an electrically connected portable computer magnetic disk with one or more wires, a hard disk, a random access memory (RAM), a read-only memory (ROM), an erasable programmable read-only memory (EPROM), a flash memory, an optical fiber, a portable compact disc read-only memory (CD-ROM), an optical storage device, a magnetic storage device, or any suitable combination of the above. In the present disclosure, the computer-readable storage medium may be any tangible medium that contains or stores a program, and the program may be used by or in combination with an instruction execution system, apparatus or device. In the present disclosure, the computer-readable signal medium may include a data signal propagated in a baseband or as a part of a carrier wave, and computer-readable program code is carried therein. This propagated data signal may take multiple forms, including but not limited to an electromagnetic signal, an optical signal, or any suitable combination of the above. The computer-readable signal medium may also be any computer-readable medium other than the computer-readable storage medium, and the computer-readable signal medium may send, propagate or transmit the program for use by or in combination with the instruction execution system, apparatus or device. The program code contained on the computer-readable medium may be transmitted by any suitable medium, including but not limited to: a wire, an optical cable, a radio frequency (RF), etc., or any suitable combination of the above.

In some implementations, the client and the server may communicate using any currently known or future developed network protocol, such as the hypertext transfer protocol (HTTP), and may be interconnected with any form or medium of digital data communication (for example, a communication network). Examples of the communication network include a local area network (LAN), a wide area network (WAN), an internet (for example, the Internet), a peer-to-peer network (for example, an Ad Hoc network), and any network currently known or to be developed in the future.

The above computer-readable medium may be included in the above electronic device, or may exist alone without being assembled into the electronic device.

The above computer-readable medium carries one or more programs, and when the one or more programs are executed by the electronic device, the electronic device is caused to execute the network isolation policy management method described in any embodiment of the present disclosure.

In the embodiments of the present disclosure, the computer program code for performing the operations of the present disclosure may be written in one or more programming languages or a combination thereof, and the above programming languages include but are not limited to object-oriented programming languages such as Java, Smalltalk, C++, and also include conventional procedural programming languages such as “C” language or similar programming languages. The program code may be executed entirely on a user computer, partly on the user computer, as a stand-alone software package, partly on the user computer and partly on a remote computer, or entirely on the remote computer or server. In the case of involving the remote computer, the remote computer may be connected to the user computer through any kind of network, including a local area network (LAN) or a wide area network (WAN), or may be connected to an external computer (for example, connected through the Internet using an Internet service provider).

The flowcharts and block diagrams in the drawings illustrate the possibly implemented architectures, functions and operations of the device, the method and the computer program product according to various embodiments of the present disclosure. In this regard, each block in the flowchart or block diagram may represent a module, program segment, or part of code, and the module, program segment, or part of code contains one or more executable instructions for implementing the specified logical functions. It should also be noted that, in some alternative implementations, the functions marked in the blocks may also occur in an order different from that marked in the drawings. For example, two blocks shown in succession may actually be executed substantially in parallel, or they may sometimes be executed in the reverse order, depending on the functions involved. It should also be noted that each block in the block diagram and/or the flowchart, and a combination of the blocks in the block diagram and/or the flowchart may be implemented by a dedicated hardware-based system that executes specified functions or operations, or may be implemented by a combination of dedicated hardware and computer instructions.

The functions described above herein may be at least partially executed by one or more hardware logic components. For example, without limitation, exemplary types of hardware logic components that may be used include: a field programmable gate array (FPGA), an application specific integrated circuit (ASIC), an application specific standard parts (ASSP), a system on chip (SOC), a complex programmable logic device (CPLD) and so on.

The above description is only a preferred embodiment of the present disclosure and an explanation of the applied technical principles. Those skilled in the art should understand that the disclosed scope involved in the present disclosure is not limited to the technical solutions formed by the specific combination of the above technical features, and should also cover other technical solutions formed by any combination of the above technical features or their equivalent features without departing from the above disclosed concept. For example, the above features and the technical features disclosed in the present disclosure (but not limited to) with similar functions are replaced each other to form a technical solution.

Furthermore, although the operations are depicted in a particular order, this should not be understood as requiring these operations to be performed in the particular order shown or in a sequential order. Under certain circumstances, multitasking and parallel processing may be advantageous. Similarly, although the above discussion contains a number of specific implementation details, these should not be interpreted as limiting the scope of the present disclosure. Certain features that are described in the context of separate embodiments may also be implemented in combination in a single embodiment. Conversely, various features described in the context of a single embodiment may also be implemented in multiple embodiments individually or in any suitable sub-combination.

Although the subject matter has been described in language specific to structural features and/or logical actions of the method, it should be understood that the subject matter defined in the appended claims is not necessarily limited to the specific features or actions described above. Conversely, the specific features and actions described above are only exemplary forms of implementing the claims.

1. A video playback method, comprising:
playing a first video in a video playback interface in a first mode in response to a triggering operation on the first video; wherein the first video at least comprises a first object; and in the first mode, interface elements irrelevant to video content of the first video are displayed in the video playback interface;
switching from the first mode to a second mode and continuing the playback of the first video in the second mode in response to detecting a preset condition; wherein in the second mode, the interface elements are not displayed in the video playback interface; and
displaying a mode exit control and at least one custom component corresponding to the first object in an edge region of the video playback interface; wherein the custom component is used for displaying extended information of at least one of the first object or an attribution party of the first object, and the extended information is information other than the video content.

2. The method of claim 1, wherein displaying the at least one custom component in the edge region of the video playback interface comprises:
displaying a first information component of the attribution party in a bottom edge region of the video playback interface; the first information component carries at least one of an attribution party identification image, an attribution party identification text or a preset attribution party description; and
displaying at least one custom information card in an upper adjacent region of the bottom edge region; the custom information card comprises an object introduction card of a product object provided by the attribution party, an object introduction card of the first object, a proxy card corresponding to the attribution party, an object conversion card of the product object, an object conversion card of the first object, an interactive task card corresponding to the first object, or an interactive task card corresponding to the attribution party.

3. The method of claim 1, wherein switching from the first mode to the second mode in response to detecting the preset condition comprises:
in response to a playback duration of the first video reaching a first preset duration, overlaying playback of a preset animation in an early stage on the video playback interface, and overlay displaying an interaction guidance prompt, an animation playback countdown and an animation exit control in a peripheral region of the preset animation in the early stage; and
in response to a first interaction operation corresponding to the interaction guidance prompt performed on the video playback interface before the animation playback countdown ends, or in response to the first interaction operation and a triggering operation on the animation exit control not being detected until the animation playback countdown ends, terminating the playback of the preset animation in the early stage, and starting playback of a preset animation in a later stage, and hiding the interaction guidance prompt, the animation playback countdown and the animation exit control; and
in response to end of the playback of the preset animation in the later stage, switching from the first mode to the second mode.

4. The method of claim 3, wherein the preset animation in the later stage comprises an associated animation element related to the first object.

5. The method of claim 4, wherein a moving start point and a moving end point of the associated animation element respectively correspond to an animation range of the preset animation in the later stage and the edge region, and the custom component displayed first in the edge region comprises the associated animation element.

6. The method of claim 3, further comprising:
in response to the triggering operation on the animation exit control before the animation playback countdown ends, terminating the playback of the preset animation in the early stage, and continuing the playback of the first video in the first mode.

7. The method of claim 1, wherein switching from the first mode to the second mode in response to detecting the preset condition comprises any of the following:
switching from the first mode to the second mode in response to a playback duration of the first video reaching a second preset duration;
switching from the first mode to the second mode in response to a second interaction operation on the video playback interface; and
switching from the first mode to the second mode in response to a triggering operation on a mode switching control displayed in the video playback interface.

8. The method of claim 2, wherein the displaying the at least one custom information card in the upper adjacent region of the bottom edge region comprises any of the following:
dynamically and circularly displaying the respective custom information cards in the upper adjacent region;
flatly displaying the respective custom information cards in the upper adjacent region according to a preset direction;
aggregately displaying the respective custom information cards in the upper adjacent region in a form of a collection; and
in response to a switching operation on the custom information card currently displayed in the upper adjacent region, displaying a next custom information card in the upper adjacent region.

9. An electronic device, comprising:
at least one processor; and
at least one memory, configured to store executable instructions;
wherein the at least one processor is configured to read the executable instructions from the at least one memory and execute the executable instructions to implement a video playback method, comprising:
playing a first video in a video playback interface in a first mode in response to a triggering operation on the first video; wherein the first video at least comprises a first object; and in the first mode, interface elements irrelevant to video content of the first video are displayed in the video playback interface;
switching from the first mode to a second mode and continuing the playback of the first video in the second mode in response to detecting a preset condition; wherein in the second mode, the interface elements are not displayed in the video playback interface; and
displaying a mode exit control and at least one custom component corresponding to the first object in an edge region of the video playback interface; wherein the custom component is used for displaying extended information of at least one of the first object or an attribution party of the first object, and the extended information is information other than the video content.

10. The device of claim 9, wherein displaying the at least one custom component in the edge region of the video playback interface comprises:
displaying a first information component of the attribution party in a bottom edge region of the video playback interface; the first information component carries at least one of an attribution party identification image, an attribution party identification text or a preset attribution party description; and
displaying at least one custom information card in an upper adjacent region of the bottom edge region; the custom information card comprises an object introduction card of a product object provided by the attribution party, an object introduction card of the first object, a proxy card corresponding to the attribution party, an object conversion card of the product object, an object conversion card of the first object, an interactive task card corresponding to the first object, or an interactive task card corresponding to the attribution party.

11. The device of claim 9, wherein switching from the first mode to the second mode in response to detecting the preset condition comprises:
in response to a playback duration of the first video reaching a first preset duration, overlaying playback of a preset animation in an early stage on the video playback interface, and overlay displaying an interaction guidance prompt, an animation playback countdown and an animation exit control in a peripheral region of the preset animation in the early stage; and
in response to a first interaction operation corresponding to the interaction guidance prompt performed on the video playback interface before the animation playback countdown ends, or in response to the first interaction operation and a triggering operation on the animation exit control not being detected until the animation playback countdown ends, terminating the playback of the preset animation in the early stage, and starting playback of a preset animation in a later stage, and hiding the interaction guidance prompt, the animation playback countdown and the animation exit control; and
in response to end of the playback of the preset animation in the later stage, switching from the first mode to the second mode.

12. The device of claim 11, wherein the preset animation in the later stage comprises an associated animation element related to the first object.

13. The device of claim 12, wherein a moving start point and a moving end point of the associated animation element respectively correspond to an animation range of the preset animation in the later stage and the edge region, and the custom component displayed first in the edge region comprises the associated animation element.

14. The device of claim 11, further comprising:
in response to the triggering operation on the animation exit control before the animation playback countdown ends, terminating the playback of the preset animation in the early stage, and continuing the playback of the first video in the first mode.

15. A non-transitory computer-readable storage medium, wherein the storage medium stores a computer program, and the computer program, when executed by at least one processor, causes the at least one processor to implement a video playback method, comprising:
playing a first video in a video playback interface in a first mode in response to a triggering operation on the first video; wherein the first video at least comprises a first object; and in the first mode, interface elements irrelevant to video content of the first video are displayed in the video playback interface;
switching from the first mode to a second mode and continuing the playback of the first video in the second mode in response to detecting a preset condition; wherein in the second mode, the interface elements are not displayed in the video playback interface; and
displaying a mode exit control and at least one custom component corresponding to the first object in an edge region of the video playback interface; wherein the custom component is used for displaying extended information of at least one of the first object or an attribution party of the first object, and the extended information is information other than the video content.

16. The non-transitory computer-readable storage medium of claim 15, wherein displaying the at least one custom component in the edge region of the video playback interface comprises:
displaying a first information component of the attribution party in a bottom edge region of the video playback interface; the first information component carries at least one of an attribution party identification image, an attribution party identification text or a preset attribution party description; and
displaying at least one custom information card in an upper adjacent region of the bottom edge region; the custom information card comprises an object introduction card of a product object provided by the attribution party, an object introduction card of the first object, a proxy card corresponding to the attribution party, an object conversion card of the product object, an object conversion card of the first object, an interactive task card corresponding to the first object, or an interactive task card corresponding to the attribution party.

17. The non-transitory computer-readable storage medium of claim 15, wherein switching from the first mode to the second mode in response to detecting the preset condition comprises:
in response to a playback duration of the first video reaching a first preset duration, overlaying playback of a preset animation in an early stage on the video playback interface, and overlay displaying an interaction guidance prompt, an animation playback countdown and an animation exit control in a peripheral region of the preset animation in the early stage; and
in response to a first interaction operation corresponding to the interaction guidance prompt performed on the video playback interface before the animation playback countdown ends, or in response to the first interaction operation and a triggering operation on the animation exit control not being detected until the animation playback countdown ends, terminating the playback of the preset animation in the early stage, and starting playback of a preset animation in a later stage, and hiding the interaction guidance prompt, the animation playback countdown and the animation exit control; and
in response to end of the playback of the preset animation in the later stage, switching from the first mode to the second mode.

18. The non-transitory computer-readable storage medium of claim 17, wherein the preset animation in the later stage comprises an associated animation element related to the first object.

19. The non-transitory computer-readable storage medium of claim 18, wherein a moving start point and a moving end point of the associated animation element respectively correspond to an animation range of the preset animation in the later stage and the edge region, and the custom component displayed first in the edge region comprises the associated animation element.

20. The non-transitory computer-readable storage medium of claim 17, further comprising:
in response to the triggering operation on the animation exit control before the animation playback countdown ends, terminating the playback of the preset animation in the early stage, and continuing the playback of the first video in the first mode.
